(19) United States
(12) Patent Application Publication
(10) Pub. No.: US 2007/0043838 A1
(43) Pub. Date: Feb. 22, 2007

(54) Device and method for remote activation/deactivation of services for communication terminals via an IP network

(75) Inventors: Jacques Litteaut, Marly Le Roi (FR); Stephane Coulon, Arronville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/504,728

(22) Filed: Aug. 16, 2006

(30) Foreign Application Priority Data
Aug. 17, 2005 (EP) 05300672.2

(51) Int. Cl. G06F 15/177

(52) U.S. Cl. 709/220

(57) ABSTRACT

A device is dedicated to the remote activation/deactivation of services for a communication terminal coupled to an Internet Protocol communication network. The device comprises management means adapted to be associated with the terminal and coupled to an instant messaging server which i) on receiving from the terminal a message to be sent to at least one destination terminal and including a request for activation/deactivation of at least one selected service, manages the sending of that message in the form of an instant message to the activation/deactivation device of the destination terminal, where applicable after converting its request into a selected language, and ii) on receiving a message from an activation/deactivation device associated with a requesting terminal, analyzes the request contained in the received message in order to determine each selected service defined in the request and then to activate or to deactivate each service so determined in order for the associated destination terminal to benefit therefrom or to cease to benefit therefrom.

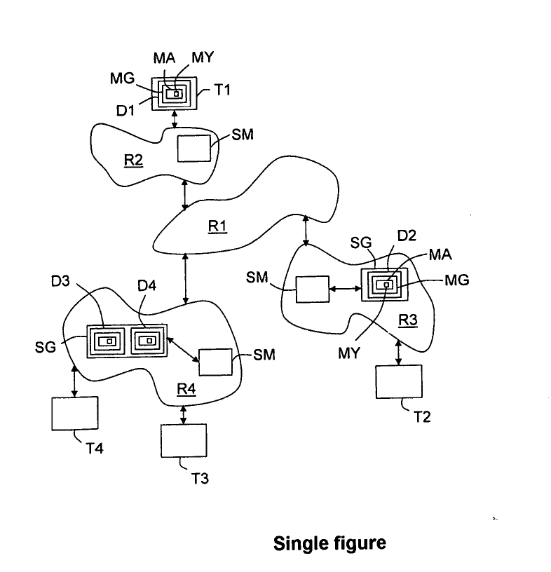

### CROSS-REFERENCE TO RELATED APPLICATIONS

This application is based on European Patent Application No. 05300672.2 filed Aug. 17, 2005, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to communication networks and more precisely to activating/deactivating services for communication terminals coupled to Internet Protocol (IP) communication networks.

2. Description of the Prior Art

As the person skilled in the art is aware, many communication networks of different types are coupled to each other but do not all offer identical or equivalent services because they are of different types and/or because they belong to different operators. Moreover, only communication applications designed by the same software producer and/or conforming to the same standardized protocol are generally compatible with each other. Also, when a service is standardized, it generally necessitates protocol improvements that take time and prevent its effective use until all network equipment manufacturers and/or all network operators have integrated the protocol improvements. It is therefore desirable to be able to activate or to deactivate one or more services on a remote terminal.

The document US 2003/0233424 describes a method for remotely activating/deactivating functions of a domestic appliance taking account of certain information describing the state of the appliance. It uses standard instant messaging. The appliance is an air conditioner, for example.

The appliance is equipped with a communication terminal coupled to the Internet, able to receive/send instant messages and coupled to a control unit for controlling the functions of the appliance. A remote user, equipped with a mobile telephone, for example, uses an instant messaging service to send instructions to the appliance and to receive in return information as to its state.

The document JP2003046657 describes a method for remotely activating/deactivating functions of an audiovisual domestic appliance via the Internet. The remote user utilizes a personal computer to send instructions via a conventional instant messaging service.

The document EP 1 549 036 describes a method for remotely activating/deactivating photographic functions of a mobile telephone using conventional instant messaging. The remote user utilizes another mobile telephone to send instructions via a conventional instant messaging service based on the Wireless Application Protocol (WAP).

The document U.S. Pat. No. 6,885,898 describes a method for remotely activating/deactivating functions of an industrial appliance or a toy taking account of certain information describing the state of the appliance or the toy. The remote user utilizes a personal computer or a mobile telephone, for example, to send instructions via a conventional instant messaging service over a local area network or the Internet.

The above prior art methods consist in particular in comparing a phrase in a message received via an instant messaging system by a telecommunication terminal associated with the appliance that is to be controlled with predetermined and prestored phrases in order to recognize which function is to be activated/deactivated.

It may happen that the received phrase is not recognized or recognized only in part because the user has forgotten the phrase that should be used or has entered it wrongly on his keypad or keyboard. The instruction then fails and the user does not know what to do to put this right.

The aim of the present invention is to propose a solution to this problem.

### SUMMARY OF THE INVENTION

According to the invention, a method of remotely activating/deactivating services for use by communication terminals coupled to an Internet Protocol communication network consists in:
i) associating with at least some of the terminals an activation/deactivation device coupled to an instant messaging service,
ii) sending from a requesting terminal to at least one activation/deactivation device associated with a destination terminal a message including a request to activate/deactivate at least one selected service in order for the requesting terminal to manage the sending of said message, in the form of an instant message, to the activation/deactivation device of each destination terminal, where applicable after converting the request into a selected language, and
iii) in each activation/deactivation device associated with a destination terminal, analyzing the request contained in said message sent in order to determine each selected service defined in said request and then activating or deactivating each service that has been determined in order for said associated destination terminal to benefit therefrom or to cease to benefit therefrom,
and, if at least a portion of a required service cannot be determined:
i) said activation/deactivation device associated with a destination terminal generates an enquiry message requesting additional information in respect of at least one of said portions that have not been determined to the activation/deactivation device associated with the requesting terminal,
ii) on receiving said enquiry message, said activation/deactivation device associated with the requesting terminal analyzes the content of said message in order to determine said requested additional information and generates a response message sent to said activation/deactivation device associated with said destination terminal and including said additional information, and
iii) on receiving said response message, said activation/deactivation device associated with the destination terminal analyzes the content of said response message in order to complete the determination of each selected service defined in the request initially received.

The method of the invention may have other features and in particular, separately or in combination:
each activation/deactivation device may convert a request contained in a message coming from the associated requesting terminal if said request is at least partially in a language different from the selected language;
each activation/deactivation device may convert a request by determining the syntax of said request and the semantics of the words that it includes and then converting at least some of said words into the selected language;
on receiving a message in an activation/deactivation device associated with a destination terminal, the syntax and the semantics of the request contained in said received message may be analyzed to determine each selected service defined in said request;
the selected language may be natural language, for example.

The invention also proposes a device for remotely activating/deactivating services for use in communication terminals coupled to an Internet Protocol communication network that includes management means adapted to be associated with a terminal and coupled to an instant messaging server, which management means are adapted:

i) on receiving from the associated terminal a message to be sent to at least one destination terminal and including a request to activate/deactivate at least one selected service, to manage the sending of that message, in the form of an instant message, to the activation/deactivation device of each destination terminal, where applicable after converting said request into a selected language, and

ii) on receiving a message from an activation/deactivation device associated with another terminal, to analyze the request contained in said received message in order to determine each selected service defined in said request and then to activate or to deactivate each service so determined in order for said associated destination terminal to benefit therefrom or to cease to benefit therefrom,

wherein said management means are adapted, if at least a portion of a requested service has not been determined, to generate an enquiry message sent to the activation/deactivation device associated with the requesting terminal to request additional information in respect of at least one of said parts that has not been determined, and said syntax and semantics analyzer means are adapted, on receiving a response message including said requested additional information, to analyze the content of said response message in order to complete the determination of each selected service defined in the request initially received.

The device of the invention may have other features and in particular, separately or in combination:
its management means may be adapted to convert a request contained in a message to be sent and coming from the associated terminal if said request is at least partially in a language other than the selected language;
its management means may include syntax and semantics analyzer means adapted, each time it is necessary to convert a request, to determine the syntax of said request and the semantics of the words that it includes, and then to convert at least some of said words into the selected language;
its management means may include syntax and semantics analyzer means adapted, on receiving a message containing a request, to analyze the syntax and the semantics of said request to determine each selected service defined in said request;
the syntax and semantics analyzer means may be adapted, on receiving an enquiry message requesting additional information, to analyze its content in order to determine said requested additional information; in this case, the management means are adapted to generate a response message sent to the activation/deactivation device associated with a destination terminal including said additional information that has been determined;
its management means may be adapted, on receiving a response message, to store the additional information it contains in their syntax and semantics analyzer means.

### BRIEF DESCRIPTION OF THE DRAWING

Other features and advantages of the invention will become apparent on reading the following detailed description and examining the appended drawing, the single FIGURE whereof shows in a highly schematic form a group of interconnected communication networks, some of which networks comprise embodiments of the activation/deactivation device of the invention and to which communication terminals are connected, one of which terminals includes an embodiment of an activation/deactivation device of the invention.

The appended drawing constitutes part of the description of the invention as well as contributing to the definition of the invention, if necessary.

### DETAILED DESCRIPTION OF THE PREFERRED EMBODIMENT

The aim of the invention is to provide remote activation/deactivation of services by communication terminals coupled to an Internet Protocol (IP) communication network.

Here the expression “terminal coupled to an IP network” refers to a terminal connected to a communication network including an IP core network or coupled to an IP core network.

Also, the expression “communication terminal” refers here to any fixed or mobile communication terminal able to exchange data in the form of signals with another communication terminal via the respective networks to which they are connected. They can therefore be fixed or mobile telephones, fixed or portable computers, or personal digital assistants (PDA), equipped with a communication module, where applicable of the IP type, for example.

In the non-limiting example shown in the single FIGURE, a first communication terminal T1 is coupled to an IP network R1 via the network R2 of its Internet service provider, a second communication terminal T2 is coupled to the IP network R1 via the private network R3 of its mobile operator, and a third communication terminal T3 and a fourth communication terminal T4 are coupled to the IP network R1 via the private network R4 of the business to which they belong. Many variants of interconnected networks may of course be envisaged.

The networks R2 to R4 may be of any type, and in particular of the cellular (or mobile) radio type, the fixed switched type (plain old telephone service (POTS) network and public switched telephone network (PSTN), the cable local area network (LAN) type or the wireless local area network (WLAN) type, for example of the WiFi type.

For example, the network R2 is a fixed switched network providing access to the Internet via an XDSL line, the network R3 is a mobile (or cellular) radio network and the network R4 is a cable local area network (LAN).

To implement the invention, each network R2 to R4 must be equipped with an instant messaging (chat service) server SM, for example an Internet Relay Chat (IRC) server. An instant messaging service SM enables terminals Ti (here i=1 to 4) that are coupled to its network and the users whereof subscribe to the instant messaging service that it manages to exchange instant messages via the IP network R1 with other terminals coupled to other networks also having an instant messaging server and the users whereof subscribe to the instant messaging service managed by that server.

To enable certain terminals Ti subscribing to an instant messaging service to activate/deactivate remotely services to which they have access when they are connected to their own network (for example the network R2 for the terminal T1 or the network R4 for the terminals T3 and T4), the invention proposes to associate with them an activation/deactivation device Di. As shown in the single FIGURE, an activation/deactivation device Di associated with a terminal Ti can either be installed in that terminal (here this applies to the device D1 installed in the terminal T1) or installed in a management server SG of the network of that terminal (here this is the case of the device D2 associated with the terminal T2 and installed in the network R3 and the devices D3 and D4 respectively associated with the terminals T3 and T4 and installed in the network R4).

Each activation/deactivation device Di comprises a management module MG associated with a terminal Ti and coupled directly or indirectly to the instant messaging server SM of the network to which the associated terminal Ti is coupled (possibly temporarily).

Each time it receives from the associated terminal Ti a message to be sent to at least one destination terminal Ti′ (i′≠i) and including a request to activate/deactivate at least one selected service, the management module MG manages the sending of that message by the instant messaging server SM to which it is coupled (and thus in the form of an instantaneous message) to the activation/deactivation device Di′ associated with each destination terminal Ti′.

If the message to be sent received by an activation/deactivation device Di contains a request that is originally in a selected language, for example natural language, the management device MG of the activation/deactivation device Di forwards the received message to the instant messaging server SM to which it is coupled in order for it to integrate the request into an instant message and to send that instant message to each activation/deactivation device Di′ associated with a destination terminal Ti′.

On the other hand, if the message to be sent received by an activation/deactivation device Di contains a request that is not originally in a selected language, the management module MG of the activation/deactivation device Di must first convert it into that selected language. The management module MG then sends a message containing the converted request to the instant messaging server SM to which it is coupled in order for it to integrate the converted request into an instantaneous message and to send that instantaneous message to each activation/deactivation device Di′ associated with a destination terminal Ti′.

Each request contained in a message to be sent is initially composed by the user of the requesting terminal Ti using the man/machine interface of said terminal Ti. The message is then sent by the requesting terminal Ti to the activation/deactivation device Di associated with it. Whichever network the requesting terminal Ti is connected to (possibly temporarily in the case of a situation of roaming in a visited network), the activation/deactivation device Di associated with it can be contacted (including when it is installed in the messaging server of its home network).

For example, a user may decide to send, by means of his terminal Ti and at least one terminal Ti′, a message containing a service activation/deactivation request for any reason, for example because he has not been able to make contact by telephone, or because he has forgotten to activate or deactivate call transfer from his fixed terminal Ti′ to his mobile terminal Ti.

For example, if the user A of a terminal T1, for example a fixed telephone connected to the network R2, has failed to contact the user B of a terminal T2, he generates a message of the “call A” or “call me back” type.

If the user A has access at this time to a first terminal T3, for example a fixed telephone connected to the network R4, and a second terminal T2, for example a mobile telephone connected to the network R3, and has forgotten to activate call transfer from his fixed terminal T3 to his mobile terminal T2, he generates a message of the “transfer my office telephone to my mobile telephone” type.

If the user knows the selected language understood by the management modules MG of the activation/deactivation devices Di, he can compose his request directly in natural language. In this case, the management module MG of the activation/deactivation device Di associated with his terminal Ti checks the syntax and the semantics of the request received using an analyzer module MA. If the syntax and semantics of the request are correct, it forwards the message containing the request to the instant messaging service SM for onward transmission.

If the user does not know the selected language understood by the management modules MG of the activation/deactivation devices Di, or does not know that language very well, he composes his request using the syntax and words of his language or partly using the syntax and/or semantics of the selected language. In this case, when the management module MG of the activation/deactivation device Di associated with his terminal Ti checks the syntax and the semantics of the request received using its analyzer module MA, it detects each syntax and/or semantic error relative to the selected language. It must then convert the received request so that it conforms to the syntax and semantics of the selected language.

The analyzer module MA preferably has a memory MY storing syntax rules and words in a first language (that of the user), for example representative of user names, service instructions or services, in corresponding relationship to their translation into the selected language and/or a communication identifier. Accordingly, if the analyzer module MA detects a syntax or semantic error relating to the selected language, it accesses its memory MY in order to determine how that error may be corrected (or converted). It can progressively convert the received request in this way.

The memory MY is preferably enriched by training it using conversion information that its activation/deactivation device Di can obtain from other activation/deactivation devices Di′ (see below).

Once the management module MG of the activation/deactivation device Di associated with the requesting terminal Ti has converted a request, it integrates it into a message that it sends to the instant messaging server SM to which it is coupled for onward transmission to each activation/deactivation device Di′ associated with a destination terminal Ti′.

Each time that it receives a message from an activation/deactivation device Di associated with a requesting terminal Ti, the management module MG analyzes the request contained in the message received to determine each selected service defined therein. Then, depending on the request, it activates or deactivates each service so determined in order for the associated destination terminal Ti′ to benefit therefrom or to cease to benefit therefrom.

As with sending, when the management module MG receives this kind of message, it analyzes the semantics and syntax of the request that it contains using its analyzer module MA. To this end, it accesses its memory MY (if it has one) to determine the meaning of the words contained in the request, allowing for its syntax.

Because the contents of the memories MY of the various activation/deactivation devices Di are not all necessarily the same, it may happen that certain words constituting a request in the selected language are unknown to an analyzer module MA. The request being then at least partly incomprehensible, the activation/deactivation device Di cannot meet it.

To solve this problem, each management module MG of an activation/deactivation device Di′ associated with a destination terminal Ti′ may be adapted to generate an enquiry message sent to the activation/deactivation device Di that sent it the message containing the request that is at least partly incomprehensible, that enquiry message requesting additional information in respect of at least one of the incomprehensible parts.

For example, the activation/deactivation device Di′ associated with a destination terminal Ti′ may receive a message containing a “call A” type request. If A is not a name stored in the memory MY of its analyzer module MA, then the management module MG generates an enquiry message to be sent to the activation/deactivation device Di that sent it the request, this enquiry message being of the “who is A?”, “what is A's telephone number?” or “What are the name and telephone number of A?” type.

The activation/deactivation device Di′ associated with a destination terminal Ti′ may receive a message containing a request of the “transfer my office telephone to my mobile telephone” type. If the word “transfer” is not stored in the memory MY of its analyzer module MA, then the management module MG generates an enquiry message to be sent to the activation/deactivation device Di that sent it the request, this enquiry message being of the “what does transfer mean?”, “what is the telephone number of the mobile terminal?” or “what does transfer mean and what is the telephone number of the mobile terminal?” type.

When an activation/deactivation device Di receives an enquiry message, its management module MG communicates it to its analyzer module MA in order for it to analyze the semantics and syntax of its content and determines the subject of the enquiry message. To this end it accesses its memory MY to understand the content of the enquiry message by looking up the words that it contains and then looking up the requested additional information.

For example, if the enquiry message is of the “what does transfer mean?” type, the additional information is of the type “transfer=ICFW” type (Immediate Call ForWarding).

If the enquiry message is of the “what is A's telephone number?” type, the additional information is of the “A's telephone number=01 xx xx xx xx” type.

When the analyzer module MA has determined the requested additional information, the management module MG generates a response message including the additional information that has been determined and sends it to the activation/deactivation device Di′ that sent it the enquiry message.

When an activation/deactivation device Di′ receives a response message after sending an enquiry message, its management module MG communicates it to its analyzer module MA in order for it to analyze the semantics and syntax of its content (additional information) and completes the determination of each selected service contained in the request initially received using the additional information contained in the response message.

Here the expression “to determine a selected service” refers to determining an instruction associated with a service. For example, in the case of a request of the “call A” type coming from the device D1 and addressed to the device D4 associated with the fixed telephone T4, the selected service is the message display service and the instruction consists in activating the message display so that the destination telephone T4 can display the message “call A” on its screen. Next time the user B of the telephone T4 uses it, he will see the message “call A” displayed on the screen.

In the presence of a “transfer my office telephone to my mobile telephone” type request coming from the device D2 associated with the mobile telephone T2 and addressed to the device D3 associated with the office (fixed) telephone T3, the selected service is the call transfer service and the instruction consists in activating call transfer from the office telephone T3 to the mobile telephone T2 (associated with D2).

In the presence of a request of the “cancel transfer” type coming from the device D2 associated with the mobile telephone T2 and addressed to the device D3 associated with the office (fixed) telephone T3, the selected service is the call transfer service and the instruction consists in deactivating call transfer from the office telephone T3 to the mobile telephone T2 (associated with D2).

Thanks to the mechanism for exchanging enquiry messages and response messages between activation/deactivation devices Di and Di′, the memories MY of their analyzer modules MA can be enriched through a training process. To this end, it is advantageous for an analyzer module MA, when it receives a new word or instruction definition or a new telephone number from an activation/deactivation device Di other than its own device Di′, to save that new definition or new number in its memory MY in order to be able to interpret it immediately if it encounters it again in a subsequent analysis.

This training solution is advantageous as it avoids having to update all the memories MY systematically, for example periodically, which would be costly in terms of time and bandwidth.

The activation/deactivation device D of the invention, and in particular its management module MG, can take the form of electronic circuits, software (or electronic data processing) modules, or a combination of circuits and software.

Activation/deactivation devices D for implementing the invention are described hereinabove. However, the invention may also be regarded as a service activation/deactivation method that may be implemented by the activation/deactivation devices D described above. The main and optional functions and sub-functions of the steps of the method being substantially identical to those of the means constituting the devices, only the steps implementing the main functions of the method of the invention are summarized hereinafter.

The method consists in:

associating with at least some of the terminals Ti an activation/deactivation device Di coupled to an instant messaging (chat service) service SM,

sending from a requesting terminal Ti to the associated activation/deactivation device Di a message including a request to activate/deactivate at least one selected service addressed to at least one other terminal Ti′ in order for it to manage the sending of that message, in the form of an instant message, to the activation/deactivation device Di′ of each destination terminal Ti′, where applicable after converting the request into a selected language, and

in each activation/deactivation device Di′ associated with a destination terminal Ti′, analyzing the requests contained in the message sent in order to determine each selected service defined in the request and then activating or deactivating each service that has been determined, in order for the associated destination terminal Ti′ to benefit from it or to cease to benefit from it.

The invention has many advantages, including the following:

each user can have his own metanetwork consisting of all of his contacts,

each business can create its own metanetwork that constitutes a superset of its corporate network and comprises networks of mobile employees, clients, suppliers and Internet users, all integrated into its own network; to this end the business can use servers that supply it with necessary information regarding the location and presence of all its contacts and employees,

new applications can be created that do not belong to terminals but to servers of any type; these new applications may provide, for example by means of a specific instant messaging account, message broadcasting services or client terminal update services (activation of new services, updating of dictionaries or vocabularies, wake-up service, for example), both for users of a personal metanetwork and for the network of clients of a business.

The invention is not limited to the activation/deactivation device and activation/deactivation method embodiments described above by way of example only, and encompasses all variants that the person skilled in the art might envisage that fall within the scope of the following claims.

1. A method of remotely activating/deactivating services for use by communication terminals coupled to an Internet Protocol communication network, said method consisting in:
i) associating with at least some of said terminals an activation/deactivation device coupled to an instant messaging service,
ii) sending from a so-called requesting terminal to at least one activation/deactivation device associated with a so-called destination terminal a message including a request to activate/deactivate at least one selected service in order for said requesting terminal to manage the sending of said message, in the form of an instant message, to the activation/deactivation device of each destination terminal, where applicable after converting said request into a selected language, and
iii) in each activation/deactivation device associated with a destination terminal, analyzing the request contained in said message sent in order to determine each selected service defined in said request and then activating or deactivating each service that has been determined in order for said associated destination terminal to benefit therefrom or to cease to benefit therefrom,
wherein, if at least a portion of a required service cannot be determined:
i) said activation/deactivation device associated with a destination terminal generates an enquiry message requesting additional information in respect of at least one of said portions that have not been determined to said activation/deactivation device associated with said requesting terminal,
ii) on receiving said enquiry message, said activation/deactivation device associated with said requesting terminal analyzes the content of said message in order to determine said requested additional information and generates a response message sent to said activation/deactivation device associated with said destination terminal and including said additional information, and
iii) on receiving said response message, said activation/deactivation device associated with said destination terminal analyzes the content of said response message in order to complete the determination of each selected service defined in the request initially received.

2. A method according to claim 1, wherein an activation/deactivation device converts a request contained in a message coming from the associated terminal if said request is at least partially in a language different from said selected language.

3. A method according to claim 2, wherein an activation/deactivation device converts a request by determining the syntax of said request and the semantics of the words that it includes and then converting at least some of said words into said selected language.

4. A method according to claim 1, wherein on receiving a message in an activation/deactivation device associated with a destination terminal, the syntax and the semantics of the request contained in said received message are analyzed to determine each selected service defined in said request.

5. A method according to claim 4, wherein on receiving said response message said activation/deactivation device associated with said destination terminal stores said additional information.

6. A method according to claim 1, wherein said language is natural language.

7. A device for remotely activating/deactivating services for use in communication terminals coupled to an Internet Protocol communication network that includes management means adapted to be associated with a terminal and coupled to an instant messaging server, which management means are adapted:
i) on receiving from the associated terminal a message to be sent to at least one so-called destination terminal and including a request to activate/deactivate at least one selected service, to manage the sending of that message, in the form of an instant message, to the activation/deactivation device of each destination terminal, where applicable after converting said request into a selected language, and
ii) on receiving a message from an activation/deactivation device associated with another terminal, to analyze the request contained in said received message in order to determine each selected service defined in said request and then to activate or to deactivate each service so determined in order for said associated destination terminal to benefit therefrom or to cease to benefit therefrom,
wherein said management means are adapted, if at least a portion of a requested service has not been determined, to generate an enquiry message sent to the activation/deactivation device associated with the requesting terminal to request additional information in respect of at least one of said parts that has not been determined, and said management means are adapted, on receiving a response message including the requested additional information, to analyze the content of said response message in order to complete the determination of each selected service defined in the request initially received.

8. A device according to claim 7, wherein said management means are adapted to convert a request contained in a message to be sent and coming from the associated terminal if said request is at least partially in a language other than said selected language.

9. A device according to claim 8, wherein said management means include syntax and semantics analyzer means adapted, if it is necessary to convert a request, to determine the syntax of said request and the semantics of the words that it includes, and then to convert at least some of said words into said selected language.

10. A device according to claim 7, wherein said management means include syntax and semantics analyzer means adapted, on receiving a message containing a request, to analyze the syntax and the semantics of said request to determine each selected service defined in said request.

11. A device according to claim 10, wherein said syntax and semantics analyzer means are adapted, on receiving an enquiry message requesting additional information, to analyze its content in order to determine said requested additional information, and wherein said management means are adapted to generate a response message sent to the activation/deactivation device associated with a destination terminal and including said additional information that has been determined.

12. A device according to claim 10, wherein said management means are adapted, on receiving a response message, to store said additional information in their syntax and semantics analyzer means.
